(19) United States
(12) Patent Application Publication
(10) Pub. No.: US 2023/0135086 A1
(43) Pub. Date: May 4, 2023

(54) RAIL FOOT HOLDER FOR FASTENING A RAIL OF AN ELEVATOR SYSTEM

(71) Applicant: Inventio AG, Hergiswil (CH)

(72) Inventor: WILLY WALKER, Buchrain (CH)

(21) Appl. No.: 16/463,889

(22) PCT Filed: Dec. 1, 2017
(86) PCT No.: PCT/EP2017/081097

§ 371 Date: May 24, 2019

(30) Foreign Application Priority Data
Dec. 7, 2016 (EP) 16202635.5

(51) Int. Cl. B66B 7/02

(52) U.S. Cl. CPC B66B 7/024

(57) ABSTRACT

A rail foot holder used in a method to fasten a rail of an elevator system in an elevator shaft has a contact body arranged in the elevator shaft in a stationary manner, at least one clamping part, and at least one intermediate part. The contact body defines a contact plane for a rail foot of the rail. The clamping part is connected to the contact body. The intermediate part is arranged between the clamping part and the contact body. When fastening the rail, a holding dimension between the clamping part and the contact plane can be set or changed for adaptation to the rail foot. The intermediate part has a fixed intermediate part height which, together with a clamping part height of the clamping part, determines the holding dimension.

### FIELD

The invention relates to a rail foot holder which is used to fasten a rail of an elevator system in an elevator shaft and a method for fastening a rail of an elevator system in an elevator shaft by means of preferably a plurality of such rail foot holders.

### BACKGROUND

What is known from EP 0 448 839 A1 is a fastening device for guide rails of elevators. The known fastening device makes it possible to change a preload force of a rail clamp. Such a change or setting of the preload force, respectively, is achieved when a semicircular profile is used as a support liner for the guide rail. That makes it necessary, however, to be determined prior to the assembly of the fastening device and therefore generally prior to the installation of the elevator system which semicircular profile is required and must be supplied as part of the fastening device. Furthermore, the rail clamp, which is spring-clamped between two disc spring packs, does not provide a defined holding dimension. In particular, the guide rail may lift here from the bearing plate, which allows in particular for the guide rail to twist around its longitudinal axis.

Another fastening device for guide rails is known from U.S. Pat. No. 4,577,729, wherein the guide rail is clamped by using an elasticity of a fastening clamp. From US2012/133164, a fastening device for guide rails is known, wherein lateral holding flanges are provided alongside the guide rail to encircle and hold a foot of the guide rail.

In the assembly of an elevator system in an elevator shaft of a building, the elevator rails (rails) can be fastened to a building wall directly or indirectly. Such an elevator rail may serve, for example, as a guide rail for an elevator car or a counterweight of the elevator system. Such elevator rails generally extend across the entire travel distance of the elevator, which is often approximately the height of the building. The elevator rails are to be fastened in the building so firmly that in particular lateral guiding forces can be safely absorbed. The height of the building may, however, change over time. This may have several causes. A building may, upon completion, shrink due to the drying out of the concrete or settle. Temperature changes and the effect of the sun may also cause the building height to change.

Height changes in the building generally do not result in compensated relative changes in length of the metal elevator rails. This means that the guide rails shift in the elevator shaft relative to the building. If the building shrinks, for example, the guide rails grow in relation to the building. To avoid deformations in the rail sections between attachment points as the result of such relative changes in length, the attachment points for a rail, in particular for a guide rail, should be formed so that a compensation in length is possible. At the same time, however, it should be made sure that the attachment of the rail satisfies the respective requirements so that, for example in the event of a guide rail, the guiding forces can be absorbed.

### SUMMARY

A task of the invention is to provide a rail foot holder which is used to fasten a rail of an elevator system in an elevator shaft and a method for fastening a rail of an elevator system in an elevator shaft by means of at least one rail foot holder that has an improved design. A more specific task of the invention may be to provide such a rail foot holder and such a method that allows for an improved fastening, whereby in particular a simplified setting and assembly is made possible and whereby, in the assembled state, both a relative displacement of the rail along its extension is possible and a movement or twisting around its extension is prevented.

Below, solutions and suggestions for a corresponding embodiment are provided that comprise a rail foot holder and a method that is performed with at least one rail foot holder and that solves at least parts of the assigned task. Furthermore, preferable supplementary or alternative further development and embodiments are provided or described.

In a solution, a rail foot holder that is used to fasten a rail of an elevator system in an elevator shaft can be formed with a contact body that can be arranged in the elevator shaft, and at least one clamping part and at least one intermediate part, whereby the contact body provides a contact plane for a rail foot of the rail, whereby the intermediate part can be arranged between the clamping part and the contact body, whereby, when fastening the rail, a holding dimension between the clamping part of the holding device and the contact plane can be set to be adapted to the rail foot, and whereby the intermediate part arranged between the clamping part and the contact body has a preset intermediate part height which determines the holding dimension together with a clamping part height of the clamping part.

Preferably, the contact body can be arranged on a fastening body in the elevator shaft. The fastening body is designed to be fastened to a wall or structure of the elevator shaft. The fastening of the fastening body is preferably settable so as to compensate for imprecisions of the building or of the elevator shaft, respectively. The contact body could also be directly integrated in the fastening body as a component of the same.

The rail (elevator rail) is not a component here of the rail foot holder. The rail foot holder may, in particular, be produced and distributed independently from a rail or other components of an elevator system. The rail foot holder is formed so that, relative to a certain arrangement of the rail, an improved arrangement and/or assembly of the rail becomes possible. It is, in particular, possible here, when the elevator system is assembled in which one or more rails are attached in the elevator shaft by means of a plurality of rail foot holders, to achieve an improved setting relative to, for example, a fastening of the rail that is free of play. This allows in particular for a compensation of production tolerances of the rail which may specifically pertain to a material strength of a rail foot. The material strength of the rail foot may, for example, fluctuate from one rail section to the next. When such rail sections are then joined to form the rail, a slightly different setting of the holding dimension may be necessary in each section. An assembler may perform this setting in a particularly easy manner when the rail is assembled in the elevator shaft.

The resulting advantage here is that the assembler can change and therefore set the holding dimension during the assembly and then secure it to a profile of the rail foot in the assembled state, which means that it is set and is therefore no longer changeable. This means as well that a holding dimension that is adjustable during the assembly, i.e., during the fastening of the rail, to the profile of the rail foot is realized, which is then affixed in the assembled state. If the rail is fastened here for example without play by means of the holding dimension so that contact between the rail foot and the contact plane or, respectively, an indirect contact with the contact plane is realized, then such contact is guaranteed during operation as well. In particular a twisting or tilting of the rail around its longitudinal axis can be avoided.

The rail foot holder may be formed so that it serves to attach the rail to only a side part of the rail foot. A correspondingly formed rail foot holder may be used for the other side part of the rail foot. What is especially conceivable here is an opposite arrangement on the two side parts of the rail foot of the rail. A rail foot holder may serve, for example, for a side part of the rail foot, while a further rail foot holder serves for a further side part of the rail foot. Here, the designation may be chosen so that a first rail foot holder is used for a first side part of the rail foot, while a second rail foot holder is used for a second side part of the rail foot.

Needless to say, the identifiers of the first side part and the second side part of the rail foot are made here the identifier of the two side parts of the rail foot, but this cannot be interpreted as a determination of which of the two side parts is identified as the first or as the second side part, respectively. In particular, the rail foot design may be modified so that the two side parts of the rail foot are designated in an interchanged manner as the first and second side part. In terms of the design, this may correspond to a mirroring of the rail foot halter on a suitable design plane. In principle, however, symmetrically identical embodiments of the rail foot holder are conceivable as well.

In another solution, a method for fastening a rail of an elevator system in an elevator shaft by means of a rail foot holder may be provided, whereby the contact body is arranged in the elevator shaft, whereby a side part of the rail foot is arranged between the clamping part and the contact plane provided by the contact body, and whereby, by pivoting the clamping part, a holding dimension is adjusted in relation to the profile of the rail foot on the side part.

When the rail is fastened, the clamping part may achieve a certain variation of the holding dimension. Here, the clamping part may be formed so that, with regard to a particular rail type, any deviations from a target geometry can be compensated. Since such tolerance-based deviations generally occur in a comparatively small area, a comparatively fine setting of the holding dimension can be realized by means of the clamping part. Comparatively big differences between the holding dimensions generally occur between different rail types. Here, the rail foot holder may be formed so that an adjustment of the holding dimension is possible at least for a certain selection of rail types. To this purpose, it may make sense to adjust the intermediate part. In practice, this means for example that the intermediate part that is used may be selected with regard to the corresponding rail type. Here, a corresponding adjustment of other components, in particular a shoulder part, which is described in further detail below, may be required. This may make an easy adjustment to different rail types possible. The application area is correspondingly larger.

It is beneficial that a side guide is formed on the intermediate part, on which, in the mounted state, the rail foot is guided on its longitudinal side that faces the intermediate part. Here, the clamping part can be positioned independently from the intermediate part to achieve the setting of the holding dimension. The intermediate part is preferably settable to the rail foot so that tolerances of the dimension of the rail foot can be absorbed in the lateral direction as well. The intermediate part may, in particular, be blocked against a twisting in relation to the contact plane. Preferably, the intermediate part may then be blocked against a linear displacement in relation to the contact plane or the fastening body. This may be achieved for example by means of a securing element such as a pin. This way, at least part of the guide forces can be reliably absorbed by the intermediate part. This relieves the stress on the clamping part. This way, the stress on a connection between the clamping part and the intermediate part can be relieved. In the assembled state, this prevents an undesired adjustment of the holding dimension that could occur during an undesired twisting of the clamping part. Furthermore, this allows for a suitable choice of material and/or geometric embodiment of the intermediate part regardless of the clamping part.

It is especially preferable for the intermediate part to have a sliding insert that forms the side guide, at least partially. Such a sliding insert may then be facing the longitudinal side of the rail foot. Here, the sliding insider may have a convex form, for example, whereby a relatively slight curvature or relatively slight curvatures are possible because, due to the blocking of the intermediate part against any twisting, no rotation-symmetrical form, in particular no cylinder barrel form, is required for the intermediate part. Because of this, the intermediate part can maintain its compact design. This applies as well for an embodiment without such a sliding insert. A slight curvature is desirable because then a rough surface of the rail foot does not adhere to the rail foot holder during a longitudinal displacement.

Additionally or alternatively, a sliding means may be provided on the side guide, at least in the assembled state. Specifically, when the intermediate part is blocked against twisting, a selective application of the sliding means may be performed on a geometry of the intermediate part that is delimited to the side guide. Any movements of the longitudinal side of the rail relative to the side guide that occur during operation may then require an advantageous distribution of the sliding means on the relevant surface. This limits the required amount of sliding means and reduces pollution problems in this regard.

It is furthermore preferable that at least the intermediate part is adjustable so that it can be adjusted to the profile of the rail foot when the rail is fastened parallel to the contact plane and so that at least the intermediate part is fastened to the contact body in a stationary manner in the assembled state. In one possible embodiment, an adjustment of the contact body together with the intermediate party may be possible in relation to a fastening structure or the like to which the contact body is fastened. This may be made possible, for example, by an arrangement of the oblong hole in the fastening structure or in the fastening body respectively. This way, the contact body together with the intermediate part can be positioned on the rail foot so that, for example, the side guide of the intermediate part comes in contact with the rail foot. The stationary attachment of the contact body then constitutes at the same time a stationary fastening of the intermediate part in the elevator shaft. In a modified embodiment, however, the contact body may first be fastened to a fastening structure or the like, which is then followed by an adjustment of the intermediate part relative to the contact body, to bring the side guide of the intermediate part in contact with the rail foot, for example. It is furthermore conceivable that a predetermined geometry of the intermediate part, which may be adapted to the type of the rail to be fastened, is mounted without any further adjustment. The latter may, in particular, make sense when a play relative to the chosen fastening, for example due to tolerances of the profile of the rail foot, can be tolerated and/or is not harmful.

In this context, it may be preferable that at least one strengthening rib is formed on the contact body that supports the intermediate part in the assembled state on a side parallel to the contact plane and facing away from the side guide of the intermediate part. The assembly may be performed in such a way that the intermediate part comes at least approximately in contact with the strengthening rib. This way, even in the case of great temporary forces, the force can be transmitted to the fastening structure by means of the contact body without any significant position changes of the intermediate part. This prevents, among other things, that the intermediate part changes its location over the course of its service life.

In one embodiment, the intermediate part may also be formed so that the side guide can be adjusted by a rotation of the intermediate part. That can be achieved by a side guide in a convex form so that a distance between a point of rotation between the intermediate part and the side guide of the intermediate part increases depending on the rotation of the intermediate part. No supporting rib may be used, however, on the contact body here. Instead of such a rib, a securing of the intermediate part by means of a pinned fitting or a screw is possible.

Furthermore, it is preferred that at least one protrusion is provided on the clamping part on which, in the assembled state, a point of contact or area of contact exists between the clamping part and the rail foot. This way, a defined fastening location can be realized. Hereby, adjustment problems that are encountered with a contact having a larger surface can be avoided from the start. It is furthermore advantageous that here the holding dimension is firmly adjusted between the point of contact or the area of contact and the contact plane in the mounted state and that the clamping part is pivotable when the rail is fastened around an axis vertically oriented to the contact plane to change the holding dimension. This allows for a setting of the holding dimension that can be ergonomically performed by an assembler.

Furthermore, it is advantageous here that a pivot range, which makes it possible to change the holding dimension by fastening the rail when the clamping part is pivoted around the axis vertically oriented to the contact plane, is not greater than 120°. Preferably, this pivot range is not greater than 90°. This results in a compact design because in the assembled state a significant overlap with the rail foot can be realized without the clamping part protruding in the side direction. This way, less space is required on the side than in a conceivable embodiment as a rotation part that permits a change of the holding dimension by means of a pivot range of at least 180°.

It is furthermore advantageous to provide a securing element that, in the assembled state, fixes the clamping part relative to the intermediate part. When the clamping part in the assembled state is secured to the intermediate part, a pivoting of the clamping part is prevented. This way, the clamping part remains in its position when in operation so that a fixed holding dimension results. The securing element may, in another embodiment, connect the clamping part together with the intermediate part to the contact body.

It is advantageous that a shoulder part is provided so that the clamping part and the intermediate part are held together in the assembled state between the shoulder part and the contact body and so that the shoulder part can be pushed against the contact body via the clamping part and the intermediate part by means of a fastening means.

It is furthermore advantageous here that the shoulder part comprises a distance section based on a tubular geometry that, in the assembled state, extends through a through bore of the clamping part and at least partially through a through bore of the intermediate part. This way, the intermediate part and the clamping part are precisely positionable and sustainable. By means of a suitable fastening means, the contact body can, at the same time, be fastened to a fastening structure or the like. Hereby, the shoulder part is pushed against the contact body by means of the clamping part and the intermediate part so that the contact body is pushed, for example, against the fastening structure by means of the fastening force. This way, the contact body can be attached in the elevator shaft in a stationary manner.

In a modified embodiment, it is, however, conceivable as well that an integrated design is realized instead of a separate design of the shoulder part and the fastening means. The fastening means can then be a component of the shoulder part and comprise a screw bolt, for example, that allows for a fastening to a fastening structure or the like by means of a washer and a nut or by a similar means.

Indirect contacts may be realized in the embodiment of the rail foot holder in several respects. The rail foot may come in direct or indirect contact with the contact body as well. Here, a suitable intermediate layer may be used which may make a sliding of the rail foot relative to the contact body easier.

It is also advantageous that a protruding securing pin or positioning catch is formed on the distance section of the shoulder part which, in the assembled state, engages in a cutout formed on the contact body. In this way, a positive connection protected against any twisting and lateral displacement may be realized between the shoulder part and the contact body. Here, an easy assembly and/or easy erection as well as a later disassembly possibility can be realized.

It is furthermore advantageous that a continuously variable clamping part height is realized by the clamping part when the rail is fastened, which is included in the holding dimension. This means that the clamping part makes possible a variable increase of the holding dimension during the assembly, which is added to the intermediate part height. This results in a compact design. In a modified embodiment, the clamping part may, however, also be formed so that the clamping part height (clamping part amount), which is continuously variable when the rail is attached, is always included in the holding dimension in a subtractive manner or, by means of a pivot range, first in an additive and then in a subtractive manner. The variable clamping part height is achieved, for example, by forming the protrusion on the clamping part or at least the respective contact surface of the clamping part so that it runs on a slanted clamping plane that is determined by the contact surface of the clamping part and the intermediate part. By rotating or pivoting the clamping part, the resulting clamping height at the point of contact with the rail foot is varied and/or adjusted in this manner.

It is advantageous as well that a clamping part used to set the holding dimension is pivoted around an axis that is vertically oriented to the contact plane, until the side part of the rail foot is at least substantially without play, but held with a practically disappearing clamping force between the clamping part and the contact plane. Then, the clamping part can be secured to the contact body when the holding dimension has been adjusted. This embodiment allows at the same time for an advantageous sliding of the rail relative to the rail foot holder as well as a fastening of the rail that is substantially free of play vis-a-vis twisting around its extension and/or around movements vertical to the contact plane.

It is advantageous that at least one contact protrusion is formed on the contact body on which the rail foot is at least indirectly supported in the assembled state. Specifically, in the case of direct support, the contact protrusion allows for a defined point of contact or area of contact with the allocated side (underside) of the rail foot. In the respective application case, this may improve a possible sliding of the rail along its longitudinal axis (extension) relative to the rail foot holder. In particular, the contact protrusion may be formed in a correspondingly smooth manner.

Preferred embodiments of the invention are explained in further detail in the description below on the basis of the attached drawings.

### DESCRIPTION OF THE DRAWINGS

FIG. 1 shows an arrangement with a rail foot holder and a further rail foot holder that are used to fasten a rail of an elevator system in an elevator shaft, in a schematic sectional view according to a first embodiment of the invention.

FIG. 2 shows a clamping part of the rail foot holder, represented in FIG. 1 from the viewpoint designated as II, together with a side view of the clamping part.

FIG. 3 shows the clamping part and a shoulder part of the rail foot holder shown in FIG. 1 from the viewpoint designated as II.

FIG. 4 shows an arrangement with a rail foot holder that is used to fasten a rail of an elevator system in an elevator shaft in a detailed schematic sectional view according to a second embodiment of the invention.

FIG. 5 shows the rail foot holder of the second exemplary embodiment illustrated in FIG. 4 in a spatial, schematic explosion view.

FIG. 6 shows an elevator system in which at least one rail with a rail foot holder is fastened according to a possible embodiment of the invention in a detailed, schematic sectional view.

### DETAILED DESCRIPTION

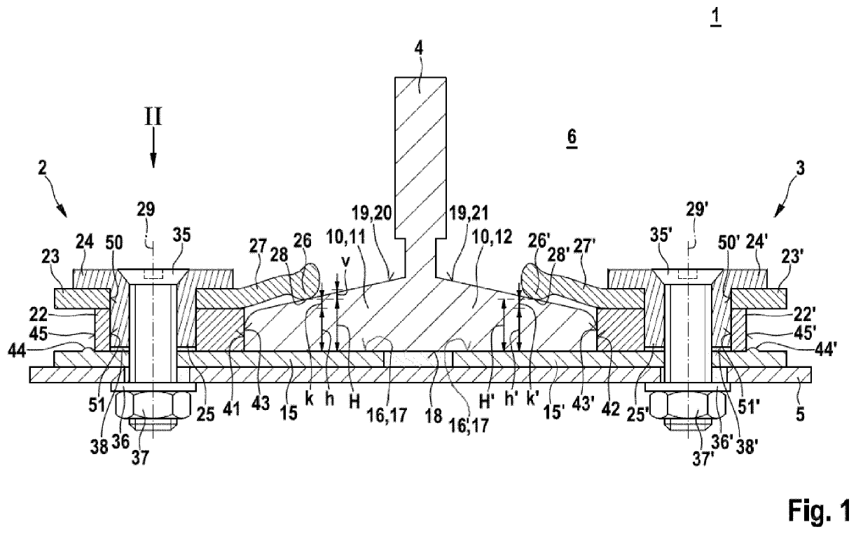

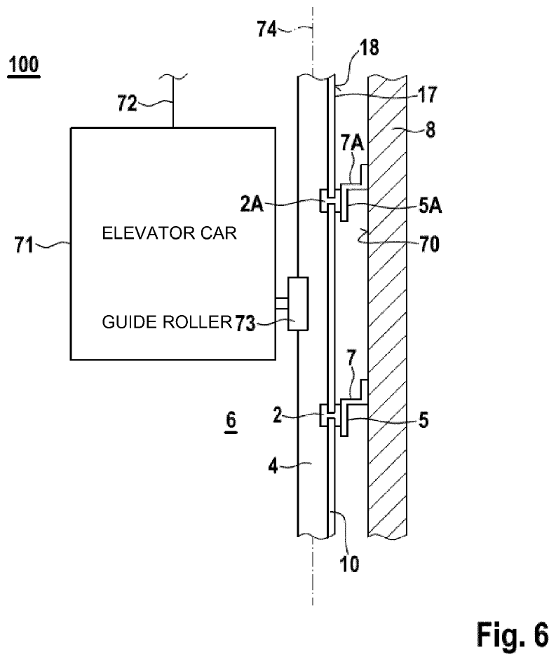

FIG. 1 shows an arrangement 1 with a rail foot holder 2 and a further rail foot holder 3 as well as a rail (elevator rail) 4 and a fastening body 5 in a schematic sectional view according to a first embodiment of the invention. Here, the fastening body 5 is arranged in an elevator shaft 6. The fastening body 5 may be part of a fastening structure 7, 7A (FIG. 6) here, which is arranged in the elevator shaft 6 in a stationary manner and which is connected for example with a shaft wall 8 (FIG. 6). Generally, the fastening body 5 is formed so that it can be set in relation to the shaft wall 8. This way, the dimension deviations of the elevator shaft 6 may be compensated. After the fastening body 5 has been set, the fastening body 5 is secured so that its location in the elevator shaft 6 is determined and therefore stationary. In a modified design, the fastening body 5 may, however, also be part of the arrangement 1 that comprises the two rail foot holders 2, 3.

The rail 4 comprises a rail foot 10. The rail foot 10 comprises a first side part 11 and a second side part 12. In this embodiment, the rail foot holder 2 is assigned to the first side part 11. The further rail foot holder 3 is assigned to the second side part 12. In the assembled state, the first rail foot holder 2 interacts with the first side part 11, and the second rail foot holder 3 interacts with the second side part 12, so that a bilateral fastening of the rail foot 10 to the fastening body 5 is achieved as it is shown in FIG. 1.

The design of the (first) rail foot holder 2 and the design of the further or second rail foot holder 3 correlate with each other in this exemplary embodiment. In this exemplary embodiment, both rail foot holders 2, 3 allow for an adaptation to the rail foot 10. In a modified design, a rail foot holder 2, 3 may be modified and in particular simplified as well.

The arrangement 1 has a contact body 15 that is assigned in this exemplary embodiment to the rail foot holder 2 and in which a further contact body 15′ is assigned to the further rail foot holder 3. The further contact body 15′ is designed in correspondence with the contact body 15 of the rail foot holder 2.

The contact body 15 comprises a contact area 16 that faces the rail foot 10 and that provides in this exemplary embodiment a contact plane 17 for the rail foot 10. The rail foot 10 has an underside 18 that faces the contact body 15 and that, in the assembled state, is aligned with the contact plane 17.

The rail foot 10 furthermore has an upper side 19 that faces away from the underside 18. The upper side 19 is divided here into a partial 20 on the first side part 11 and a partial 21 on the second side part 12.

The rail foot holder 2 comprises an intermediate part 22 and a clamping part 23. Furthermore, a shoulder part 24 is provided on which, in this exemplary embodiment, a distance section 25 is formed. The distance section 25 is formed in this exemplary embodiment as a tubular distance section 25. The distance section 25 may, specifically, have the shape of a hollow cylinder here. In general, the distance section 25 may be based on a tubular geometry where slits or other recesses may be inserted into the distance section 25.

In the assembled state, a protrusion 26 formed on a clamping part shoulder 27 of the clamping part 23 lies against a contact 28 on the partial area 20 of the upper side 19 of the rail foot 10. The contact is a point of contact 28 or an area of contact 28 that allows for a small-sized contact. This results in a holding dimension H between the protrusion 26 and the contact plane 17 with which the first side part 11 of the rail foot 10 is held. In the assembled state, the holding dimension H is firmly set.

The intermediate part 22 has an intermediate part height h which is firmly set by the geometry of the intermediate part 22 and which is additively included in the holding dimension H. In addition to the intermediate part height h, a clamping part height k results on the clamping part 23 which is included in the holding dimension H as well. The holding dimension H results from the sum of the intermediate part height h and the clamping part height k. A value of the clamping part height k may be positive or negative here.

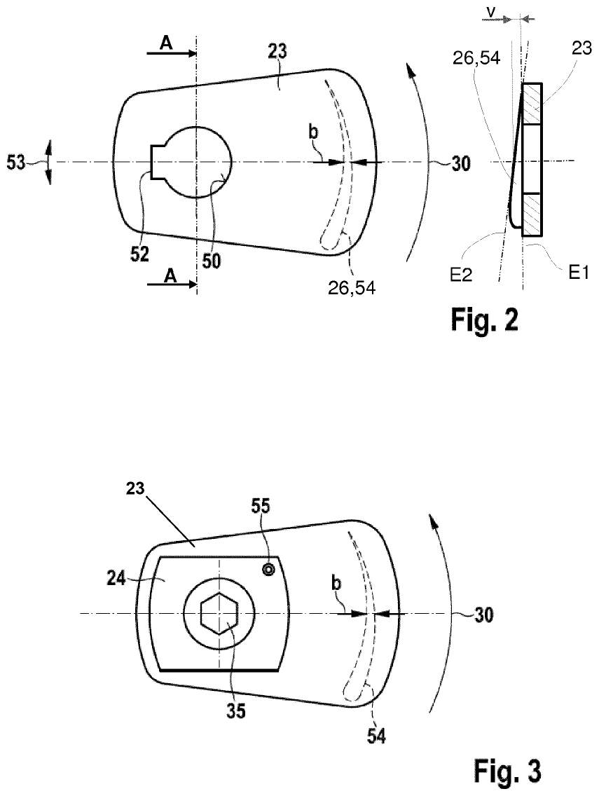

During the assembly, the clamping part 23 is pivotable by an axis 29 of the rail foot holder 2. The clamping part height k may be varied by such pivoting. This may be realized in such a way, for example, that the protrusion 26 is formed opposite to a pivoting direction 30 (FIG. 2) with a varying height v. Since the point of contact 28 is at least substantially stationary on the upper side 19 of the rail foot 10 when the clamping part 23 is pivoted in the pivoting direction 30, the clamping part height k decreases accordingly as the height v of the protrusion at the point of contact 28 increases. This decreases the holding dimension H accordingly.

Depending on the design of the clamping part 23, the clamping part height k may always be added to the intermediate part height h to obtain the holding dimension H. This corresponds to a preferred embodiment because, this way, the total height of the rail foot holder 2 can be reduced along its axis 29 and thus a compact design achieved. In embodiments that are modified accordingly, the clamping part height k may even be a negative amount or always make a negative contribution to the holding dimension H. Therefore, the clamping part height k may also be included in the holding dimension H in a subtractive manner so that the holding dimension H may be smaller than the intermediate part height h. In particular in designs in which the clamping part height k can reduce the intermediate part height h (as well), the clamping part height k may also simply be referred to as the clamping part contribution k. The holding dimension H is therefore ultimately determined by a predetermined intermediate part height h of the intermediate part together with the clamping part height k of the clamping part 23, whereby the clamping part contribution k may have positive or negative values.

The rail foot holder 2 comprises a fastening means 35 that is designed in this exemplary embodiment as a screw bolt 35. During assembly, the shoulder part 24 is pushed against the contact body 15 by means of the screw bolt 35 and a nut 37 supported at the fastening body 5 by means of a washer 36 to secure the clamping part 23. Then, the holding dimension H is firmly set in the assembled state. In the assembled state, the shoulder part 24 is supported at the contact body 15 by means of the clamping part 23 and the intermediate part 22. To ensure a secure clamping, the distance section 25 is shortened. A front side (support surface) 38 of the distance section 25 is recessed correspondingly.

In the same way, the further rail foot holder 3 comprises an intermediate part 22′, a clamping part 23′, a shoulder part 24′ with a distance section 25′, on which a front side 38′ is formed, a screw bolt 35′, a washer 36′, and a nut 37′. Here, the clamping part 23′ is pivotable in the respective manner around an axis 29′ of the further rail foot holder 3. Furthermore, a clamping part shoulder 27′ with a protrusion 26′ is formed on the clamping part 23′. On the protrusion 26′, a contact 28′ in the form of a point of contact 28′ or an area of contact 28′ is determined relative to the partial surface 21 of the upper side 19 of the rail foot 10 on the second side part 12, when the rail foot holder 3 is mounted to the rail 4.

On the further rail foot holder 3, a holding dimension H′ may be set between the contact 28′ and a contact plane 17′ of the further contact body 15′. The holding dimension H′ is comprised here of the intermediate part height h′ of the intermediate part 22′ and a clamping part height k′ of the clamping part 23′. Here, the intermediate part height h′ always makes an additive contribution to the holding dimension H′. The contribution k′ that is contributed by the clamping part 23′ to the holding dimension H′ is preferably included in the holding dimension H′ in an additive manner. The clamping part 23′ may, however, be formed so that the contribution k′ is deducted from the intermediate part height h′ over at least a partial area to set the holding dimension H′.

The foot rail 10 comprises on its first side part 11 a first longitudinal side 41 and on its second part 12 a second longitudinal side 42. The first longitudinal side 41 on the first side part 11 faces the intermediate part 22. The second longitudinal side 42 of the rail foot 10 on the second side part 12 faces the intermediate part 22′.

A side guide 43 is formed on the intermediate part 22 on which, in the mounted state, the rail foot 10 is guided along its longitudinal side 41. Accordingly, a side guide 43′ on the intermediate part 22′ makes it possible to guide the rail foot 10 on its second longitudinal side 42.

A strengthening rib 44 is formed on the contact body 15 that supports the intermediate part 22 in the assembled state on a side 45 perpendicular to the contact plane 17 and facing away from the side guide 43 of the intermediate part 22. In addition to the fastening of the intermediate part 22 by means of the shoulder part 24, the forces that occur may therefore be braced by means of the supporting rib 44 as well. For the intermediate part 22′, a corresponding supporting rib 44′ is formed on the side 45′ of the intermediate part 22′ on the contact body 15′.

The rail foot holders 2, 3 can therefore be set in this embodiment together with the respective contact bodies 15, 15′ so that they can be attached to a precisely determined width of the rail foot 10. Longitudinal holes are, for example, arranged in the fastening body 5 for this purpose.

Alternatively, the two contact bodies 15, 15′ may be made from one piece. In this case, however, the lateral support ribs 44, 44′ must be left out to allow for a setting of the intermediate parts 22, 22′ at the width of the rail.

FIG. 2 shows the clamping part 23 of the rail foot holder 2 shown in FIG. 1 from the viewpoint identified as II, and in the same FIG. 2 a lateral sectional view is shown along line A-A. The clamping part 23 comprises a through bore 50 through which the distance section 25 extends in the assembled state. Accordingly, a through bore 51 (FIG. 1) is formed on the intermediate part 22. In this exemplary embodiment, the through bore 50 is expanded by an optional groove 52. The design of the groove 52 may, at the most, prevent a pivoting around the axis 29 to a pivoting range 53. Here, a suitable rib may engage in the groove 52 at the distance section 25. An unlimited design may be realized as well in which there is no groove 52.

In this exemplary embodiment, a dotted line 54 illustrates a design of the protrusion 26. Here, a width b of the protrusion 26 decreases in the pivoting direction 30 from as, hereby accordingly, as shown in the lateral sectional view, the height v of the protrusion 26 decreases as well. In other words, the variable height v is achieved by having a clamping plane E2 that is determined by the course of the protrusion 26 run to a contact plane E1 that lies against the intermediate part 22 in a slanted manner. By rotating or pivoting the clamping part, the resulting clamping height is varied at the point of contact with the rail foot. Consequently, during assembly, the clamping part 23 can be pivoted in the pivoting direction 30 until the side part 11 of the rail foot 10 is at least substantially without play, but held with a practically disappearing clamping force between the clamping part 23 and the contact plane 17. In the example of FIG. 2, the height v of the protrusion 26 corresponds at the same time to the clamping part height k of FIG. 1.

FIG. 3 shows the clamping part 23 and the shoulder part 24 of the rail foot holder 2 shown in FIG. 1 from the viewpoint identified as II. During the assembly, the shoulder part 24 is secured by means of the fastening means 35. When the holding dimension H is set, the clamping part 23 is secured to the clamping part shoulder 27 by means of a securing element 55. This means that, after the fastening, the clamping part 23 can no longer pivot. This prevents in particular a displacement caused by shearing forces that occur during operation. This way, the holding dimension H is firmly set. By means of the shoulder part 24, the clamping part 23 is then secured to the contact body 15 and can no longer pivot around the axis 29. A possible security element 55 is a pin, for example, which is inserted after the assembly. When necessary, the pin or the fastening element 55 may be pushed through the clamping part 23, the intermediate part 22, and the contact body 15 until it reaches the fastening body 5. This way, the entire rail foot holder 2 may be protected against a displacement.

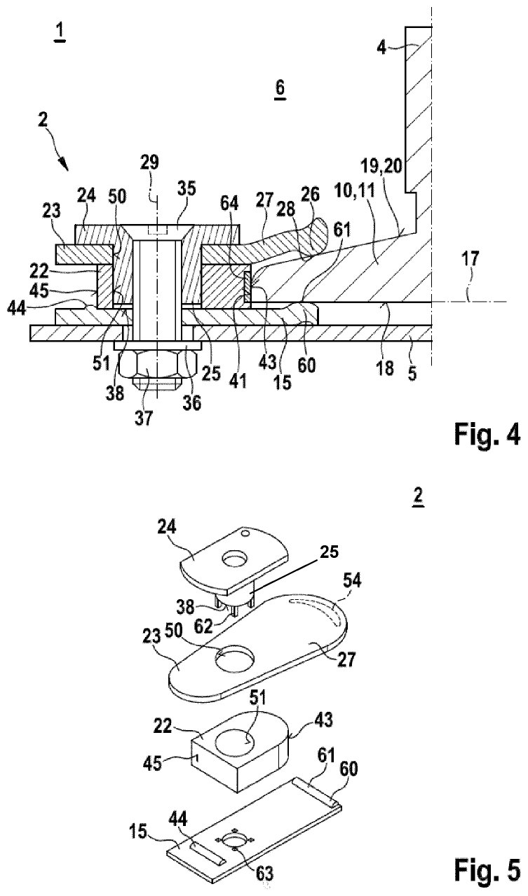

FIG. 4 shows an arrangement 1 with a rail foot holder 2 that is used to fasten a rail 4 in an elevator shaft 6 in a detailed, schematic sectional view according to a second embodiment of the invention. In this exemplary embodiment, the contact body 15 of the arrangement 1 is formed as a part of the rail foot holder 2, while a further contact body 15′ is provided for the further rail foot holder 3. On the contact body 15, at least one contact protrusion 60 is formed in this exemplary embodiment on which the rail foot 10 is supported on its underside 18 in the assembled state. This provides direct support. In a modified design, indirect support may be provided, for example by arranging an intermediate layer on the underside 18 of the rail foot 10. This provides at least indirect support.

A point or line-shaped contact 61 for the rail foot 10 is realized on the support protrusion 60. The contact plane 17 is then defined together with further such supports that correspond to support 61 on further rail foot holders that correspond to the rail foot holder 2. The rail foot holder 2 is then positioned relative to the contact plane 17. Here, the contact plane 17 does not necessarily have to be located on the contact protrusion 60 because, in a modified embodiment, a space formed by one or more contact layers is conceivable.

FIG. 5 shows the rail foot holder 2 of the second embodiment from FIG. 4 in a spatial, schematic explosion view. In this embodiment, securing pins 62 are provided on the distance section 25 that protrude over the front side (support surface) 38. To simplify the illustration, only the securing pin 62 is identified. During the assembly, the securing pins 62 are inserted into the respectively formed cutouts 63 of the contact body 15. To make the illustration easier to understand, only the cutout 63 is identified here. In the assembled state, the securing pins 62 then extend into the respective cutouts 63. This way, a form-fitting connection is realized between the clamping part shoulder 27 and the contact body 15.

In this embodiment, the side guide 43 is realized as a convexly shaped surface 43 on the intermediate part 22. During the assembly, a suitable sliding means may be applied to the side guide 43. Furthermore, the side guide 43 may be formed on a sliding insert 64 (FIG. 4) inserted into the intermediate part 22. This way, improved sliding properties may be realized for the rail foot 10.

FIG. 6 shows an elevator system 100 in which a rail 4 with a number of rail foot holders 2, 2A is fastened in an elevator shaft 6 in a detailed, schematic sectional view. The rail foot holders 2, 2A may here be formed in accordance with the first embodiment described in FIG. 1, the second embodiment described in FIG. 4, or in accordance with any of the modifications mentioned. In this exemplary embodiment, the fastening body 5 is part of a fastening structure 7 which is fastened to a side 70 of the shaft wall 8. The fastening body 5 is connected with the fastening structure 7 so that it can be set. Accordingly, a fastening structure 7A with a fastening body 5A is provided for the rail foot holder 2A. The contact plane 17 is defined on the underside 18 of the rail foot 10 of the rail 4 by means of the rail foot holders 2, 2A.

The rail 4 may be used as a guide rail 4 and/or retarder 4. Here, a diagram of an elevator car 71 is shown that is suspended on a suspension means 72 in the elevator shaft 6. A guide roller 73 attached to the elevator car 71 may act together with the rail 4 for example. Any guide forces occurring during operation may then be reliably transferred from the rail 4 to the shaft wall 8 by means of the rail foot holders 2, 2A.

If the dimensions of the building change due to a settling of the building, temperature-related length changes, or the like, relative changes in length may occur between the shaft wall 8 and the rail 4. Such changes in length occur along an extension 74 of the rail 4. The rail foot holders 2, 2A allow here a compensation of the length because the rail 4 can slide through the rail foot holders 2, 2A along its extension 74.

Consequently, both a reliable fastening of the rail 4 in the elevator shaft 6 is realized as well as an advantageous movement of the rail 4 along its extension 74 to compensate for relative changes in length.

The invention is not limited to the exemplary embodiments and the modifications described.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A rail foot holder for fastening a rail of an elevator system in an elevator shaft, the rail foot holder having a contact body arranged in the elevator shaft, a clamping part and an intermediate part, whereby a contact plane for a rail foot of the rail is defined by the contact body, and whereby the intermediate part is arranged between the clamping part and the contact body, comprising:
when the rail is fastened in the elevator shaft by the rail foot holder, a holding dimension between the clamping part and the contact plane can be set for adaptation to the rail foot and the intermediate part arranged between the clamping part and the contact body has a fixed intermediate part height which, together with a clamping part height of the clamping part, determines the holding dimension,
whereby the holding dimension, in an assembled state of the rail and the rail foot holder, is firmly set between a point of contact or an area of contact on the clamping part and the contact plane; and
whereby the clamping part is pivotable relative to the intermediate part around an axis that is oriented vertical to the contact plane, when the rail is fastened, to change the holding dimension.

17. The rail foot holder according to claim 16 including a side guide formed on the intermediate part on which, in the assembled state, the rail foot is guided along a longitudinal side of the rail foot that faces the intermediate part.

18. The rail foot holder according to claim 17 wherein the intermediate part can be set for adaptation to the rail foot when the rail is fastened parallel to the contact plane and the intermediate part is secured relative to the contact body stationarily in the assembled state.

19. The rail foot holder according to claim 17 wherein the intermediate part has at least one of a sliding insert that at least partially forms the side guide and a sliding means provided on the side guide in the assembled state.

20. The rail foot holder according to claim 17 including at least one strengthening rib formed on the contact body that supports the intermediate part in the assembled state on a side of the intermediate part facing away from the side guide of the intermediate part.

21. The rail foot holder according to claim 16 including a protrusion formed on the clamping part, wherein in the assembled state the point of contact or the area of contact is located between the protrusion and the rail foot.

22. The rail foot holder according to claim 21 wherein the clamping part has a contact plane determined by a contact surface between the clamping part and the intermediate part and the protrusion has a clamping plane, wherein the clamping plane extends slanted relative to the contact plane.

23. The rail foot holder according to claim 21 wherein the clamping part has a pivot range around the axis not greater than one of 90° and 120° for changing the holding dimension.

24. The rail foot holder according to claim 21 including a securing element that, in the assembled state, connects the clamping part relative to at least one of the intermediate part and the contact body so that the holding dimension is firmly set in the assembled state.

25. The rail foot holder according to claim 16 including a shoulder part holding the clamping part and the intermediate part together, in the assembled state, between the shoulder part and the contact body and a fastening means pushing the shoulder part against the contact body.

26. The rail foot holder according to claim 25 wherein the shoulder part has a distance section with a tubular geometry that, in the assembled state, extends through a through bore of the clamping part and through a through bore of the intermediate part and at least one securing pin formed on the shoulder part that protrudes over an end surface of the distance section and that, in the assembled state, engages in a cutout formed on the contact body.

27. The rail foot holder according to claim 16 wherein the clamping part provides a continuously variable clamping part height when the rail is fastened and as a result the holding dimension is correspondingly variable.

28. The rail foot holder according to claim 16 including a contact protrusion formed on the contact body on which contact protrusion the rail foot is at least indirectly supported in the assembled state.

29. A method for fastening a rail of an elevator system in an elevator shaft by at least one rail foot holder according to claim 16, comprising the steps of:
arranging the contact body in the elevator shaft;
arranging a side part of the rail foot between the contact plane provided by the clamping part and the contact body; and
pivoting the clamping part to set the holding dimension in relation to the rail foot.

30. The method according to claim 29 including pivoting the clamping part around the axis until the rail foot is held without play to prevent twisting or tilting of the rail relative to a longitudinal axis of the rail, but the rail foot is held with a clamping force between the clamping part and the contact plane that permits longitudinal displacement of the rail relative to the rail foot holder, and securing the clamping part relative to the contact body when the holding dimension is set.
